(19) United States
(12) Patent Application Publication
(10) Pub. No.: US 2013/0230104 A1
(43) Pub. Date: Sep. 5, 2013

(54) METHOD AND APPARATUS FOR ENCODING/DECODING IMAGES USING THE EFFECTIVE SELECTION OF AN INTRA-PREDICTION MODE GROUP

(71) Applicants: Jinhan Song, Seoul (KR); Jeongyeon Lim, Gyeonggi-do (KR); Tae Young Jung, Seoul (KR); Yong Hoon Kim, Gyeonggi-Do (KR); Jechang Jeong, Seoul (KR)

(72) Inventors: Jinhan Song, Seoul (KR); Jeongyeon Lim, Gyeonggi-do (KR); Tae Young Jung, Seoul (KR); Yong Hoon Kim, Gyeonggi-Do (KR); Jechang Jeong, Seoul (KR)

(73) Assignee: SK TELECOM CO., LTD., Seoul (KR)

(21) Appl. No.: 13/821,455

(22) PCT Filed: Sep. 7, 2011
(86) PCT No.: PCT/KR2011/006626

§ 371 Date: May 20, 2013

(30) Foreign Application Priority Data
Sep. 7, 2010 (KR) 10-2010-0087387

(51) Int. Cl. H04N 7/26

(52) U.S. Cl. CPC H04N 19/00569
USPC 375/240.12

(57) ABSTRACT

A video encoding/decoding method and apparatus select a prediction mode set based on neighboring pixels and, in some embodiments, obviate the need to encode additional information for selecting a prediction mode set and thereby improve the performance of compression.

### CROSS-REFERENCE TO RELATED APPLICATION

The instant application is the US national phase of PCT/KR2011/006626 filed Sep. 7, 2011 which is based on, and claims priority from, KR Application Serial Number 10-2010-0087387, filed on Sep. 7, 2010. The disclosures of the above-listed applications are hereby incorporated by reference herein in their entirety.

### TECHNICAL FIELD

The present disclosure relates in some embodiments to a video encoding/decoding method and apparatus.

### BACKGROUND

The statements in this section merely provide background information related to the present disclosure and may not constitute prior art.

Along with the development of information and communication technology including the Internet, visual communications have been increased in addition to text and voice communications. In addition to text-centered communication scheme, there are increasing multimedia services that may include various types of information such as texts, images, music, and the like. The amount of multimedia data is huge and thus, multimedia data requires large-capacity storage media and/or wide bandwidths for transmission. Therefore, to transmit multimedia data including texts, images, and audio data etc., a compression encoding scheme may be required.

A basic principle of compressing data involves a process of removing data redundancy. Data may be compressed by removing a spatial redundancy such as when the same color or object is repeated in an image, a temporal redundancy as when few changes occur among neighboring frames in a video frame or as when the same note is repeated in an audio signal, or psychovisual redundancy that considers human sight and perception being insensitive to a high frequency.

Among such video compressing methods, H.264 to AVC (Advanced Video Coding) further improves compression efficiency over MPEG-4 (Moving Picture Experts Group-4). As one of schemes to improve the compression efficiency, H.264 uses directional intra-prediction (hereinafter simply referred to as intra-prediction) to remove a spatial similarity within a frame. The intra-prediction predicts values of a current block by copying pixels neighboring the current block on its upper and left side locations in a predetermined direction, and encodes only the differences between pixel values of the current block and the predicted block.

On the other hand, an inter-prediction (temporal prediction) performs prediction referring to areas of a frame located at temporally different locations. The inter-prediction is complementary to the intra-prediction. Depending on circumstances, one of the two prediction methods is more advantageous than, and is selected over, the other for encoding the image.

According to the H.264 intra-prediction, a predicted block of a current block is generated based on another block that has an earlier coding order. Then, a value obtained by subtracting the predicted block from the current block is encoded. With respect to a luminance component, the predicted block is generated by the unit of 4×4 block or 16×16 block (also referred to as macro block). There are nine selectable prediction modes for each 4×4 block, and four selectable prediction modes for each 16×16 block. From among the prediction modes, a video encoder according to H.264 selects a prediction mode that causes the smallest difference between the current block and the predicted block.

With a plurality of selectable prediction mode sets provided, additional information on what is selected among the prediction mode sets is also encoded.

### SUMMARY

At least an embodiment of the present disclosure provides a video encoding/decoding apparatus and method including a video encoder selecting an intra-prediction mode set by using neighboring pixels of a current block, generating a predicted block by using the selected intra-prediction mode set, generating a residual block by subtracting the predicted block from the current block, and generating encoded data from the residual block. The video encoding/decoding apparatus and method further includes a video decoder receiving and decoding encoded data to generate decoded data, reconstructing a residual block from the decoded data, selecting an intra-prediction mode set by using neighboring pixels of a current block to be reconstructed, generating, based on the selected intra-prediction mode set, a predicted block of the current block to be reconstructed, and reconstructing the current block by adding the reconstructed residual block and the predicted block of the current block to be reconstructed.

At least another embodiment of the present disclosure provides a video encoding apparatus and method including an intra-predictor selecting an intra-prediction mode set by using neighboring pixels of a current block, and generating a predicted block by using the selected intra-prediction mode set; a subtractor generating a residual block by subtracting the predicted block from the current block; and an encoder generating encoded data from the residual block.

Yet at least another embodiment of the present disclosure provides a video decoding apparatus and method including a decoder receiving and decoding encoded data to generate decoded data; an intra-predictor selecting an intra-prediction mode set by using neighboring pixels of a current block, and generating a predicted block by using the selected intra-prediction mode set; and an adder reconstructing the current block by adding the reconstructed residual block and the predicted block.

### DESCRIPTION OF DRAWINGS

FIG. 1 is a block diagram of a video encoding apparatus according to one or more embodiments of the present disclosure;

FIG. 2 is a block diagram of an intra-predictor according to one or more embodiments;

FIG. 3 is a diagram illustrating pixels in a 4×4 current block and various pixels neighboring the current block, according to one or more embodiments;

FIG. 4 is a diagram illustrating various intra-prediction mode sets, according to one or more embodiments;

FIG. 5 is a flowchart of a process in which a mode set selector selects a mode set according to one or more embodiments;

FIG. 6 is a flowchart of a video encoding method according to at least one embodiment of the present disclosure;

FIG. 7 is a block diagram of a video decoding apparatus according to one or more embodiments of the present disclosure;

FIG. 8 is a block diagram of an intra-predictor, according to one or more embodiments; and

FIG. 9 is a flowchart of a video decoding method according to at least one embodiment of the present disclosure.

### DETAILED DESCRIPTION

At least one embodiment of the present disclosure provides an improvement in the performance of compression by selecting a prediction mode set based on neighboring pixels and/or omitting encoding of additional information for selecting a prediction mode set.

Hereinafter, embodiments of the present disclosure will be described in detail with reference to the accompanying drawings. In the following description, like reference numerals designate like elements although they are shown in different drawings. Further, detailed descriptions of known functions and/or configurations will be omitted for the purpose of clarity.

Additionally, various terms, such as first, second, A, B, (a), (b), etc., are used solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via one or more additional components.

A video encoding apparatus and/or a video decoding apparatus according to one or more embodiments may correspond to a user terminal such as a PC (personal computer), a notebook computer, a tablet, a PDA (Personal Digital Assistant), a game console, a PMP (portable multimedia player), a PSP (PlayStation Portable), a wireless communication terminal, a smart phone, a TV, a media player, and the like. A video encoding apparatus and/or a video decoding apparatus according to one or more embodiments may correspond to a server terminal such as an application server, a service server, and the like. A video encoding apparatus and/or a video decoding apparatus according to one or more embodiments may correspond to various devices each including (a) a communication device such as a communication modem that performs communication with various devices or wired/wireless communication networks, (b) a memory that stores various programs and data that encode or decode an image or perform inter/intra-prediction for encoding or decoding, and (c) a microprocessor to execute a program so as to perform calculation and controlling, and the like. According to one or more embodiments, the memory comprises a computer-readable recording/storage medium such as a random access memory (RAM), a read only memory (ROM), a flash memory, an optical disk, a magnetic disk, a solid-state disk, and the like. According to one or more embodiments, the microprocessor is programmed for performing one or more of operations and/or functionality described herein. According to one or more embodiments, the microprocessor is implemented, in whole or in part, by specifically configured hardware (e.g., by one or more application specific integrated circuits or ASIC(s)).

According to one or more embodiments, an image that is encoded by the video encoding apparatus into a bit stream may be transmitted, to the video decoding apparatus in real time or non-real time, through a wired/wireless communication network such as the Internet, a wireless personal area network (WPAN), a wireless local area network (WLAN), a WiBro (wireless broadband, aka WiMax) network, a mobile communication network, and the like or through various communication interfaces such as a cable, a USB (Universal Serial Bus), and the like. According to one or more embodiments, the bit stream may be decoded in the video decoding apparatus and may be reconstructed to a video, and the video may be played back. According to one or more embodiments, the bit stream is stored in a computer-readable recording/storage medium.

In general, a video may be formed of a series of pictures (also referred to herein as “images” or “frames”), and each picture is divided into predetermined regions such as blocks. The divided blocks may be classified into an intra-block and an inter-block based on an encoding scheme. The intra-block refers to a block that is encoded based on an intra-prediction coding scheme. The intra-prediction coding scheme predicts pixels of a current block by using pixels of blocks that were encoded and decoded to be reconstructed in a current picture to which encoding is to be performed, so as to generate a predicted block, and encodes pixel differences between the predicted block and the current block. The inter-block means a block that is encoded based on an inter-prediction coding scheme. The inter-prediction coding scheme predicts a current block in a current picture referring to at least one previous picture and/or at least one subsequent picture, so as to generate a predicted block, and encodes differences between the predicted block and the current block. Here, a frame that is referred to in encoding or decoding the current picture (i.e., current frame) is called a reference frame.

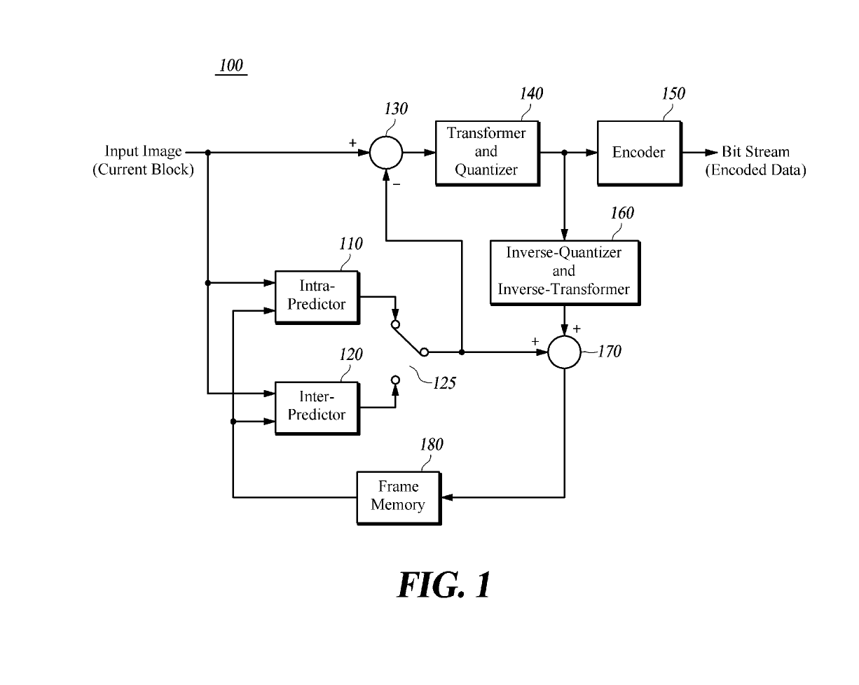

FIG. 1 is a block diagram of a video encoding apparatus 100 according to one or more embodiments of the present disclosure.

The video encoding apparatus 100 according to at least one embodiment of the present disclosure may include an intra-predictor 110, an inter-predictor 120, a selector 125, a subtractor 130, a transformer and quantizer 140, an encoder 150, an inverse-quantizer and inverse-transformer 160, an adder 170, and a frame memory 180.

An image to be encoded may be input in units of blocks. In the present disclosure, each block is an array of M×N pixels, where M and N may each have a size of 2ⁿ, and M and N may be the same or different from each other. Therefore, the block may be equal to or larger than a macro block of H.264.

The intra-predictor 110 and/or the inter-predictor 120 may generate a predicted block by predicting a current block. That is, the predictor 110 or 120 may predict a pixel value of each pixel of the current block to which encoding is to be performed in an image, and may generate a predicted block having a predicted pixel value of each pixel. Here, the predictor 110 or 120 may predict the current block through intra-prediction performed by the intra-predictor 110 or the inter-prediction performed by the inter-predictor 120.

The inter-predictor 120 may generate a predicted block using a different frame (i.e., a reference frame) so as to predict a current block. According to one or more embodiments, the inter-predictor 120 generates a motion vector through motion estimation based on a mode of the inter-predictor 120 in a previous frame that already passes through an encoding process and is decoded, and generates a predicted block in a motion compensation process using the motion vector.

The intra-predictor 110 generates an intra-predicted block by predicting pixels of a current block using pixels neighboring the current block (i.e., neighboring pixels). According to one or more embodiments, the inter-predictor 110 generates a predicted block by selectively performing filtering on the intra-predicted block based on a correlation among the neighboring pixels of the current block or a correlation among pixels of the intra-predicted block. That is, the intra-predictor 110 may generate the predicted block based on a mode of the intra-predictor 110 by using already encoded and reconstructed neighboring pixels of the current block.

The selector 125 selects one of the predicted blocks generated by the predictors 110 and 120, and outputs the selected predicted block to the subtractor 130. The subtractor 130 generates a residual block by subtracting the predicted block outputted by the selector 125 from the current block. That is, the subtractor 130 calculates the difference between a pixel value of each pixel of the current block to encode and a pixel value of the predicted block generated from the intra-predictor 110 or inter-predictor 120, so as to generate the residual block.

According to one or more embodiments, the transformer and quantizer 140 transforms and quantizes the residual block generated from the subtractor 130 into a frequency coefficient so as to generate a transformed and quantized residual block. Here, an appropriate transforming method may be a scheme that transforms an image in a spatial domain into a frequency domain, such as the Hadamard transform and the discrete cosine transform based integer transform (hereinafter referred to as ‘integer transform’). As a quantizing scheme, DZUTQ (dead zone uniform threshold quantization) or quantization weighted matrix and the like may be used.

The encoder 150 encodes the residual block transformed and quantized by the transformer and quantizer 140 so as to generate encoded data.

An entropy encoding scheme may be used as the encoding scheme, but this disclosure may not be limited thereto and various encoding schemes may be used in various embodiments.

In addition, the encoder 150 may include, in the encoded data, a bit stream obtained by encoding quantized frequency coefficients and various information required for decoding the encoded bit stream. That is, the encoded data may include a first field including a bit stream obtained by encoding a CBP (coded block pattern), a delta quantization parameter and a quantization frequency coefficient, a second field including information required for prediction (for example, an intra-prediction mode in the case of intra-prediction, a motion vector in the case of inter-prediction, and the like) and others.

The inverse-quantizer and inverse-transformer 160 inverse-quantizes and inverse-transforms the transformed and quantized residual block that is transformed and quantized by the transformer and quantizer 140, so as to reconstruct the residual block. The inverse-quantization and inverse-transform may be the inverse processes of the transform and quantization performed by the transformer and quantizer 140. That is, the inverse-quantizer and inverse-transformer 160 may perform inverse-quantization and inverse-transform by inversely performing the transform and quantization scheme performed by the transformer and quantizer 140 based on information associated with the transform and quantization (for example, information of a transform and quantization type) that is generated and transferred from the transformer and quantizer 140.

The adder 170 reconstructs the current block by adding the predicted block predicted by the predictor 110 or 120 and the residual block inverse-quantized and inverse-transformed by the inverse-quantizer and inverse-transformer 160.

The frame memory 180 stores the block reconstructed by the adder 170, and uses the stored block as a reference block to generate a predicted block during intra or inter-prediction.

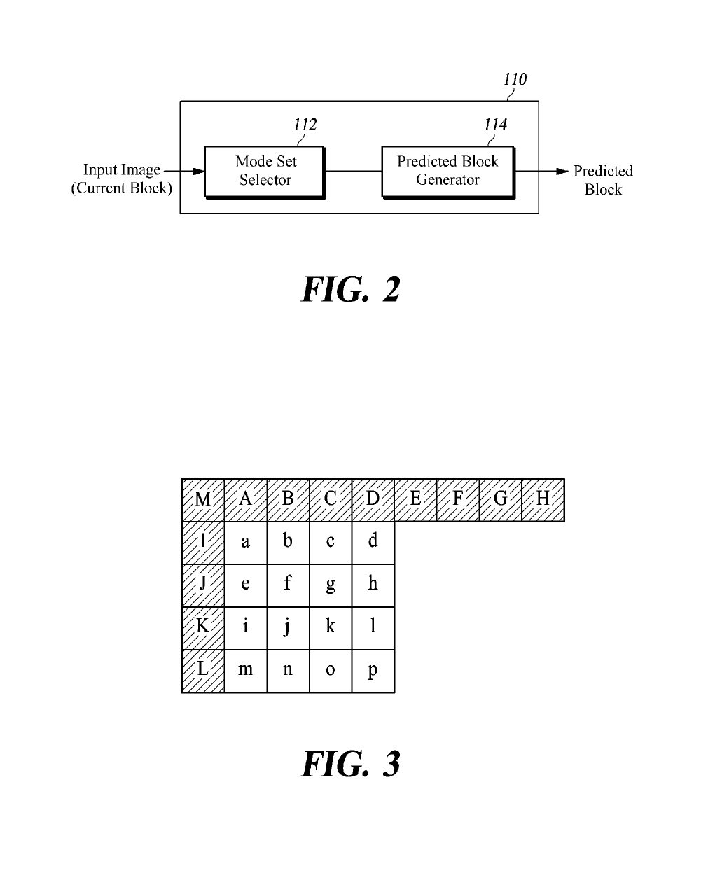

FIG. 2 is a diagram of the intra-predictor 110 according to one or more embodiments.

The intra-predictor 110 selects a set of intra-prediction modes by using neighboring pixels of a current block, and generates a predicted block with one prediction mode in the selected intra-prediction mode set.

As illustrated in FIG. 2, the intra-predictor 110 may be configured to include a mode set selector 112 and a predicted block generator 114.

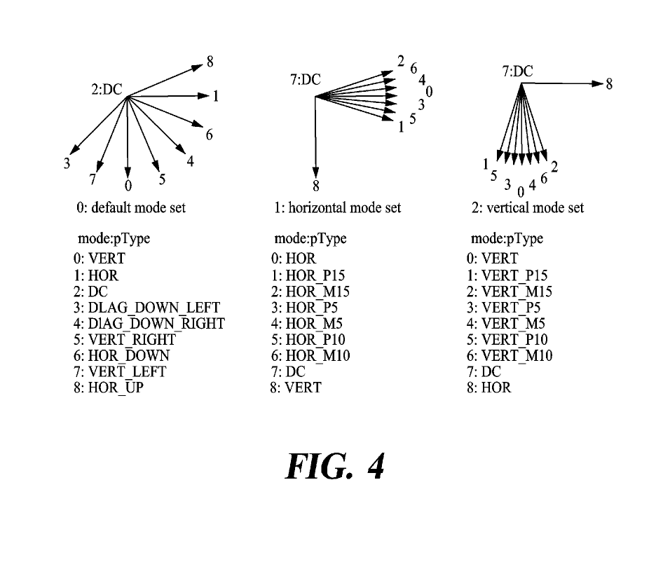

FIG. 3 is a diagram illustrating pixels (a˜p) of a 4×4 current block and pixels (A˜M) neighboring the current block, according to one or more embodiments. FIG. 4 is a diagram illustrating various intra-prediction mode sets according to one or more embodiments. According to one or more embodiments, the intra-prediction mode sets are prediction mode sets in the H.264 standard and detailed descriptions of such H.264 standard prediction mode sets will be omitted. Other prediction mode sets are within the scope of various embodiments.

The mode set selector 112 selects an intra-prediction mode using neighboring pixels of the current block. The mode set selector 112 selects the intra-prediction mode set based on a correlation among the neighboring pixels of the current block. The correlation may correspond to a standard deviation or variance among the neighboring pixels of the current block, but the present disclosure is not limited thereto.

The mode set selector 112 may calculate a correlation among neighboring pixels based on variances obtained by Equation 1 and Equation 2.

$$\begin{matrix}{σ}_{T} = {\sum }_{P = \{ A , B , C , D \}} {( P - {Mean}_{A , B , C , D} )}^{2} & Equation 1 \\ {σ}_{L} = {\sum }_{P = \{ I , J , K , L \}} {( P - {Mean}_{I , J , K , L} )}^{2} & Equation 2\end{matrix}$$

where P denotes each pixel and Mean denotes a mean value.

Equation 1 calculates a variance among neighboring pixels A-D located in the upper side of the current block, and Equation 2 calculates a variance among neighboring pixels I-L located in the left side of the current block. The neighboring pixels A-D belong to a neighboring block located in the upper side of the current block, and the neighboring pixels I-L belong to a further neighboring block located in the left side of the current block. Pixel values of the neighboring pixels are known from previous encoding of the corresponding neighboring blocks, are stored in the frame memory 180, are supplied to the predictor 110 and/or 120 from the frame memory 180.

The variances obtained by Equation 1 or Equation 2 are compared to a threshold value (TH) obtained by Equation 3 to determine whether a correlation exists.

$$TH = \frac{{Q}_{step}^{2} + 8}{16} \qquad Equation 3$$

In Equation 3, Qₛₜₑₚ denotes a quantization step parameter.

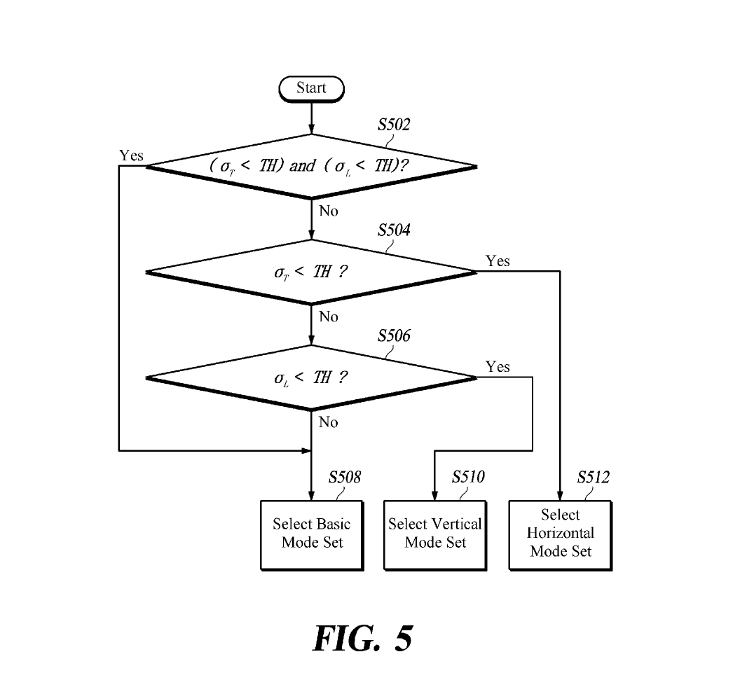

FIG. 5 is a flowchart of a process in which the mode set selector 112 selects a mode set.

As illustrated in FIG. 5, it is determined whether two conditions of (σ_{T}<TH) and (σ_{L}<TH) are satisfied in step S502, and a basic (default) mode set (FIG. 4) is selected in step S508 when the two conditions are satisfied. When it fails to satisfy both of the two conditions, it is determined whether the condition of (σ_{T}<TH) is satisfied in step S504. When the condition of (σ_{T}<TH) is satisfied, a horizontal mode set (FIG. 4) is selected in step S512. When the condition of (σ_{T}<TH) is not satisfied, it is determined whether the condition of (σ_{L}<TH) is satisfied in step S506. When the condition of (σ_{L}<TH) is satisfied, a vertical mode set (FIG. 4) is selected in step S510. When the condition of (σ_{L}<TH) is not satisfied, the basic (default) mode set is selected in step S508.

The predicted block generator 114 generates a predicted block using a mode set selected by the mode set selector 112. According to one or more embodiments, the predicted block is generated by using a prediction mode that provides an optimal efficiency from among the prediction modes included in the selected mode set. For example, according to H.264, among the prediction modes included in the selected mode set, the prediction mode that causes the smallest difference in pixel value between the current block and the predicted block is used by the predicted block generator 114 to generate the predicted block based on the neighboring pixels.

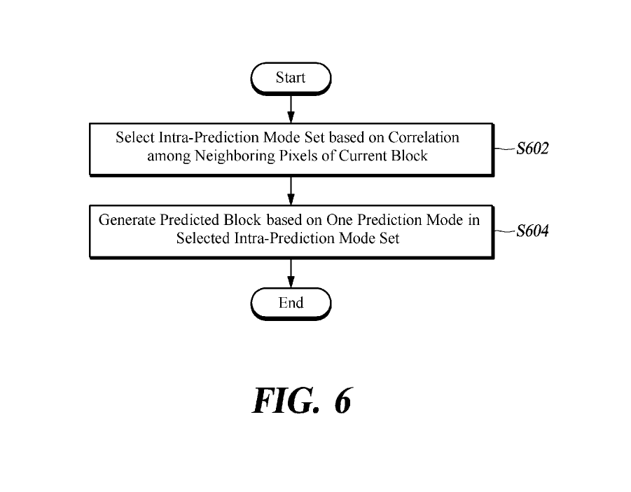

FIG. 6 is a flowchart of a video encoding method according to one or more embodiments of the present disclosure.

As illustrated in FIG. 6, the video encoding method according to at least an embodiment of the present disclosure includes a mode set selection step S602 for selecting an intra-prediction mode set based on a correlation among neighboring pixels of a current block, and a predicted block generation step S604 for generating a predicted block by using one prediction mode in the selected intra-prediction mode set.

Here, the mode set selection step S602 corresponds to the operation of the mode set selector 112, and the predicted block generation step S604 corresponds to the operation of the predicted block generator 114 and thus, detailed descriptions thereof will be omitted.

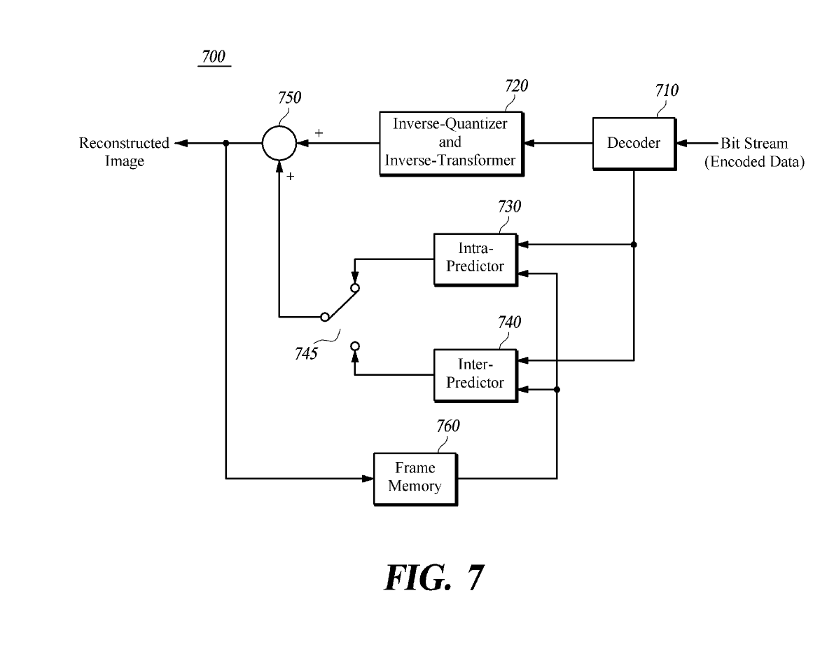

FIG. 7 is a block diagram of a video decoding apparatus 700 according to one or more embodiments of the present disclosure.

The video decoding apparatus 700 according to at least an embodiment of the present disclosure may be configured to include a decoder 710, an inverse-quantizer and inverse-transformer 720, an intra-predictor 730, an inter-predictor 740, a selector 745, an adder 750, and a frame memory 760.

The decoder 710 generates decoded data from received encoded data. For example, the decoder 710 extracts a transformed and quantized residual block and information required for decoding, from the received encoded data.

The decoder 710 may decode the encoded data so as to extract information required for block decoding. The decoder 710 may extract and decode an encoded residual block from a first field included in the encoded data, and transfer the decoded transformed and quantized residual block to the inverse-quantizer and inverse-transformer 720. The decoder 710 may further extract information required for prediction from a second field included in the encoded data, and transfer the extracted information required for prediction to the intra-predictor 730 and/or the inter-predictor 740.

The inverse-quantizer and inverse-transformer 720 may inverse-quantize and inverse-transform the decoded transformed and quantized residual block so as to reconstruct a residual block.

The intra-predictor 730 and/or the inter-predictor 740 generates a predicted block by predicting a current block, using pixel values of neighboring pixels provided by the frame memory 760. In this example, the corresponding predictor 730 or 740 may predict the current block in the same manner as the predictor (intra-predictor 110 or the inter-predictor 120) of the video encoding apparatus 100.

The selector 745 selects one of the predicted blocks generated by the predictors 730 and 740, and outputs the selected predicted block to the adder 750. The adder 750 reconstructs the current block by adding the residual block reconstructed by the inverse-quantizer and inverse-transformer 720 and the predicted block generated by the predictor 730 or 740. The current block reconstructed by the adder 750 may be transferred to the frame memory 760 and thus, may be utilized in the predictor 730 or 740 for predicting another block.

The frame memory 760 may store a reconstructed image to make it available for generating intra and/or inter-predicted blocks.

The decoder 710 may decode the encoded data so as to decode or extract the transformed and quantized residual block and the information required for decoding. The information required for decoding means information required for decoding an encoded bit stream included in the encoded data and may be, for example, block type information, information of an intra-prediction mode in a case where a prediction mode is an intra-prediction mode, information of a motion vector in a case where the prediction mode is an inter-prediction mode, information of a transform and quantization type, and the like among other various information.

The intra-predictor 730 selects an intra-prediction mode set by using neighboring pixels of the current block, and generates a predicted-block by using the selected intra-prediction mode set.

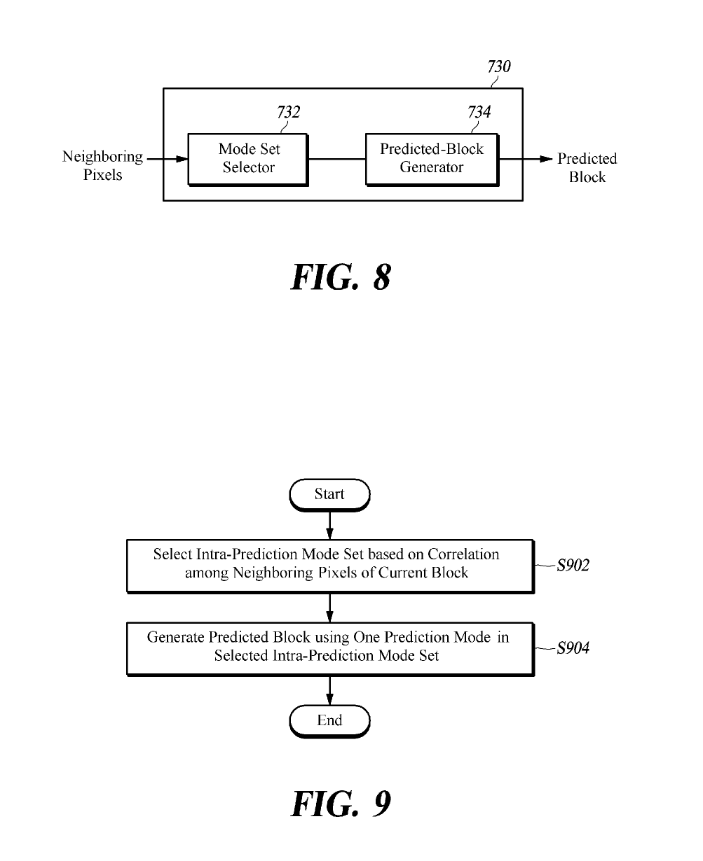

FIG. 8 is a diagram of the intra-predictor 730 according to one or more embodiments.

As illustrated in FIG. 8, the intra-predictor 730 includes a mode set selector 732 and a predicted block generator 734.

The mode set selector 732 selects an intra-prediction mode set based on a correlation among neighboring pixels of a current block. The operation of the mode set selector 732 in the video decoding apparatus 700 may be the same as or similar to the operation of the mode set selector 112 in the video encoding apparatus 100 and thus, detailed descriptions thereof will be omitted.

The predicted block generator 734 generates a predicted block by using the mode set selected by the mode set selector 732. That is, the predicted block may be generated by selecting a prediction mode that provides an optimal efficiency from among the prediction modes included in the selected mode set. The operation of the predicted block generator 734 in the video decoding apparatus 700 may be the same as or similar to the operation of the predicted block generator 114 in the video encoding apparatus 100 and thus, detailed descriptions thereof will be omitted.

FIG. 9 is a flowchart of a video decoding method according to one or more embodiments of the present disclosure.

As illustrated in FIG. 9, the video decoding method according to at least an embodiment of the present disclosure includes a mode set selection step S902 for selecting a set of intra-prediction modes based on a correlation among neighboring pixels of a current block, and a predicted block generation step S904 for generating a predicted block by using one prediction mode in the selected intra-prediction mode set.

Here, the mode set selection step S902 corresponds to the operation of the mode set selector 732 and the predicted block generation step S904 corresponds to the operation of the predicted block generator 734 and thus, detailed descriptions thereof will be omitted.

A video encoding/decoding apparatus according to at least an embodiment of the present disclosure may be embodied by connecting an encoded data output of the video encoding apparatus 100 of FIG. 1 to an encoded data input of the video decoding apparatus 700 of FIG. 7.

For example, a video encoding/decoding apparatus according to at least an embodiment of the present disclosure includes a video encoder for selecting an intra-prediction mode set by using neighboring pixels of a current block, generating, by using the selected intra-prediction mode set, generating a residual block by subtracting the predicted block from the current block, generating a transformed and quantized residual block by transforming and quantizing the residual block, and encoding the transformed and quantized residual block; and a video decoder for reconstructing a transformed and quantized residual block by receiving encoded data, reconstructing a residual block by inverse-quantizing and inverse-transforming the reconstructed transformed and quantized residual block, selecting an intra-prediction mode set by using neighboring pixels of a current block to be reconstructed, generating, based on the selected intra-prediction mode set, a predicted block of the current block to be reconstructed, and reconstructing the current block by adding the reconstructed residual block and the predicted block of the current block to be reconstructed.

Here, the video encoder may be embodied by the video encoding apparatus 100 according to at least an embodiment of the present disclosure, and the video decoder may be embodied by the video decoding apparatus 700 according to at least an embodiment of the present disclosure.

A video encoding/decoding method according to at least an embodiment of the present disclosure may be embodied by combining the video encoding method described above according to at least an embodiment of the present disclosure and the video decoding method described above according to at least an embodiment of the present disclosure.

For example, a video encoding/decoding method according to at least an embodiment of the present disclosure includes performing a video encoding process by selecting an intra-prediction mode set by using neighboring pixels of a current block, generating a predicted block by using the selected intra-prediction mode set, generating a residual block by subtracting the predicted block from the current block, generating a transformed and quantized residual block by transforming and quantizing the residual block, and encoding the transformed and quantized residual block; and performing a video decoding process by reconstructing a transformed and quantized residual block by receiving encoded data, reconstructing a residual block by inverse-quantizing and inverse-transforming the reconstructed transformed and quantized residual block, selecting an intra-prediction mode set by using neighboring pixels of a current block to be reconstructed, generating, based on the selected intra-prediction mode set, a predicted block of the current block to be reconstructed, and reconstructing the current block by adding the reconstructed residual block and the predicted block of the current block to be reconstructed.

According to various embodiments of the present disclosure as described above, a prediction mode set is selected based on neighboring pixels and thus, it is possible to omit encoding additional information for selecting a prediction mode set in some embodiments to improve the performance of compression.

In the description above, although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules residing in computer readable media and causing a processor or microprocessor to execute functions of the hardware equivalents. The computer program may be stored in computer readable media, which in operation can realize the embodiments of the present disclosure. The computer readable media include, but are not limited to, magnetic recording media, and optical recording media.

In addition, terms like ‘include’, ‘comprise’, and ‘have’ should be interpreted in default as inclusive or open-ended rather than exclusive or close-ended unless expressly defined to the contrary. All the terms that are technical, scientific or otherwise agree with the meanings as understood by a person skilled in the art unless defined to the contrary.

Although exemplary embodiments of the present disclosure have been described for illustrative purposes, those skilled in the art will appreciate that various modifications, additions and substitutions are possible, without departing from various characteristics of the disclosure. Therefore, exemplary embodiments of the present disclosure have not been described for limiting purposes.

1-18. (canceled)

19. A video encoding/decoding apparatus, the apparatus comprising:
a video encoder configured to
select an intra-prediction mode set by using neighboring pixels of a current block,
generate a predicted block by using the selected intra-prediction mode set,
generate a residual block by subtracting the predicted block from the current block, and
generate encoded data from the residual block; and
a video decoder configured to
receive and decode encoded data to generate decoded data,
reconstruct a residual block from the decoded data,
select an intra-prediction mode set by using neighboring pixels of a current block to be reconstructed,
generating, based on the selected intra-prediction mode set, a predicted block of the current block to be reconstructed, and
reconstruct the current block by adding the reconstructed residual block and the predicted block of the current block to be reconstructed.

20. A video encoding apparatus, comprising:
an intra-predictor configured to
select an intra-prediction mode set by using neighboring pixels of a current block, and
generate a predicted block by using the selected intra-prediction mode set;
a subtractor configured to generate a residual block by subtracting the predicted block from the current block; and
an encoder configured to generate encoded data from the residual block.

21. The apparatus of claim 20, wherein the intra-predictor comprises:
a mode set selector configured to select the intra-prediction mode set based on a correlation among the neighboring pixels of the current block; and
a predicted block generator configured to generate the predicted block by using one prediction mode in the selected intra-prediction mode set.

22. The apparatus of claim 20, wherein the intra-predictor is configured to select the intra-prediction mode set based on a correlation among the neighboring pixels arranged along at least one side of the current block.

23. The apparatus of claim 22, wherein the correlation includes a standard deviation or variance among the neighboring pixels.

24. The apparatus of claim 20, further comprising:
a transformer and quantizer configured to generate a transformed and quantized residual block by transforming and quantizing the residual block;
wherein the encoder is configured to encode the transformed and quantized residual block to generate the encoded data.

25. The apparatus of claim 24, further comprising:
an inverse-quantizer and inverse-transformer configured to reconstruct the residual block by inverse-quantizing and inverse-transforming the transformed and quantized residual block;
an adder configured to reconstruct the current block by adding the predicted block and the reconstructed residual block; and
a frame memory configured to store the reconstructed current block for encoding of a subsequent block.

26. A video decoding apparatus, comprising;
a decoder configured to receive encoded data and generate decoded data;
an intra-predictor configured to
select an intra-prediction mode set by using neighboring pixels of a current block, and
generate a predicted block by using the selected intra-prediction mode set; and
an adder for reconstructing the current block by adding a residual block reconstructed from the decoded data and the predicted block.

27. The apparatus of claim 26, wherein the intra-predictor comprises:
a mode set selector configured to select the intra-prediction mode set based on a correlation among the neighboring pixels of the current block; and
a predicted block generator configured to generate the predicted block by using the selected intra-prediction mode set and prediction mode information reconstructed by the decoder.

28. The apparatus of claim 26, wherein the intra-predictor is configured to select the intra-prediction mode set based on a correlation among the neighboring pixels arranged along at least one side of the current block.

29. The apparatus of claim 28, wherein the correlation includes a standard deviation or variance among the neighboring pixels.

30. The apparatus of claim 26, wherein the decoder is configured to extract a transformed and quantized residual block from the encoded data,
the apparatus further comprising:
an inverse-quantizer and inverse-transformer configured to generated the reconstructed residual block by inverse-quantizing and inverse-transforming the transformed and quantized residual block.

31. A video encoding/decoding method performed by the video encoding/decoding apparatus of claim 1, the video encoding/decoding method comprising:
performing, by the video encoder, a video encoding comprising:
selecting an intra-prediction mode set by using neighboring pixels of a current block,
generating a predicted block by using the selected intra-prediction mode set, and
generating encoded data from the residual block; and
performing, by the video decoder, a video decoding comprising:
receiving and decoding encoded data to generate decoded data,
reconstructing a residual block from the decoded data,
selecting an intra-prediction mode set by using neighboring pixels of a current block to be reconstructed,
generating, based on the selected intra-prediction mode set, a predicted block of the current block to be reconstructed, and
reconstructing the current block by adding the reconstructed residual block and the predicted block of the current block to be reconstructed.

32. A video encoding method performed by the video encoding apparatus of claim 20, the video encoding method comprising:
performing, by the intra-predictor, an intra-prediction by
selecting an intra-prediction mode set by using neighboring pixels of a current block, and
generating a predicted block by using the selected intra-prediction mode set;
generating a residual block by the subtractor subtracting the predicted block from the current block; and
generating, by the encoder, encoded data from the residual block.

33. The method of claim 32, wherein the performing the intra-prediction comprises:
selecting the intra-prediction mode set based on a correlation among the neighboring pixels of the current block; and
generating the predicted block by using one prediction mode in the selected intra-prediction mode set.

34. The method of claim 32, wherein the performing the intra-prediction comprises:
selecting the intra-prediction mode set based on a correlation among the neighboring pixels arranged along at least one side of the current block.

35. The method of claim 34, wherein the correlation includes a standard deviation or variance among the neighboring pixels.

36. A video decoding method performed by the video decoding apparatus of claim 26, the method comprising:
receiving and decoding, by the decoder, encoded data to generate decoded data;
performing, by the intra-predictor, an intra-prediction by
selecting an intra-prediction mode set by using neighboring pixels of a current block, and
generating a predicted block by using the selected intra-prediction mode set; and
reconstructing the current block by the adder adding a residual block reconstructed from the decoded data and the predicted block.

37. The method of claim 36, wherein the performing the intra-prediction comprises:
selecting the intra-prediction mode set based on a correlation among the neighboring pixels.

38. The method of claim 37, wherein the correlation includes a standard deviation or variance among the neighboring pixels.
